(19) United States
(12) Patent Application Publication
(10) Pub. No.: US 2006/0093716 A1
(43) Pub. Date: May 4, 2006

(54) Apparatus and method for cutting tofu and other foods

(76) Inventor: Zhi Ming Wu, San Francisco, CA (US)

Correspondence Address: West & Associates;a Professional Corporation, Suite 180, 800 West El Camino Real, Mountain View, CA, 94040, US

(21) Appl. No.: 10/978,892

(22) Filed: Nov. 1, 2004

(51) Int. Cl. A23P 1/00

(52) U.S. Cl. 426/518

(57) ABSTRACT

A method and apparatus for cutting tofu and other soft foods into uniform pieces. A receptacle is fit onto a standard sized tofu package which cuts open the tofu package covering. The cover material is removed and discarded to expose the tofu. A cutting piece is fit into the top of the receptacle and firmly pressed into the tofu until the cutters reach the bottom of the tofu container. The cutter and receptacle is removed from the tofu container and the uniformly cut tofu pieces are now ready for use.

### BACKGROUND

1. Field of the Invention

The present invention is related to a method and apparatus for opening packages of tofu and other soft foods, and cutting it into uniform shapes and sizes.

2. Description of the Related Art

Tofu, also known as soybean curd, is a soft, cheese-like food made by curdling fresh hot soyamilk with a coagulant. Traditionally, the curdling agent used to make tofu is nigari, a compound found in natural ocean water, or calcium sulfate, a naturally occurring mineral. Curds also can be produced by acidic foods like lemon juice or vinegar. The curds then are generally pressed into a solid block.

Three main types of tofu are commonly available. Firm tofu is dense and solid. Soft tofu is a good choice for recipes that call for blended tofu, or in Oriental soups. Silken tofu is made by a slightly different process than the other 2 types and is a soft, custard-like product.

Tofu, by its nature, has a short shelf life and is easily spoiled if not handled or kept properly. To increase the time it can be safely sold to consumers, tofu is commonly sold in vacuum-packed containers. These standardized containers are almost invariably comprised of a plastic tray that holds water in which a block of tofu sits in, which is sealed with a plastic film on top.

To open the package, the food preparer commonly has to use a sharp knife to cut the film, which can be dangerous because she can easily cut through the package and injure herself. She can also easily spill the water the tofu is packed in if she cut through the package on the side or the bottom.

Since tofu is commonly sold as a block, it becomes necessary to cut it down to size for use in food dishes. A food preparer can use a simple knife to cut the tofu, but even the most skilled of chefs will find it extremely difficult and/or time-consuming to get perfectly shaped edges and uniformly sized blocks. Further, the tofu may have to be physically handled by the food preparer, which may result in contamination of the food.

When cooking with tofu, it is desirable to cut the tofu into uniform shapes and sizes for two main reasons. First, having the pieces in uniform shape and size is very important when cooking the tofu, because different sized pieces will cook at different rates and result in over- and under-cooked pieces. Secondly, poorly cut tofu shows a lack of skill on the part of the chef, which is undesirable.

Therefore, it is desirable to provide a method and apparatus for allowing people to easily open a package of tofu, cut the tofu contained within into uniform visually pleasing shapes, without the need to remove the tofu from the package first. It is desirable for this to be accomplished with a small, cheap, and simple device. It is desirable that this device be effortless, fast, and safe. It is also desirable that this device can take advantage of the commonly available standardized tofu packages as it is sold to the public.

### BRIEF DESCRIPTION OF THE DRAWINGS

FIG. 1 depicts a perspective view of the top portion of an embodiment of the device disclosed herein.

FIG. 2 is a perspective view of the bottom portion of an embodiment the device.

FIG. 3 is a side view one particular embodiment of the cutting blades that are a part of the top portion of the device.

FIG. 4 depicts a side view of an alternate embodiment of the top portion of the device that makes use of wires as a cutting surface.

FIG. 5 is a side view of a standard sized tofu container.

FIG. 6 is a top down view of one embodiment of the top portion that makes use of wire blades and a movable wire blade.

FIG. 7 is a side view of the movable wire blade structure shown in FIG. 6.

FIG. 8 is a side view of the elastic tension mechanisms that pull the top portion out of the food once it has been cut and downward pressure on the top portion has been removed.

### DETAILED DESCRIPTION

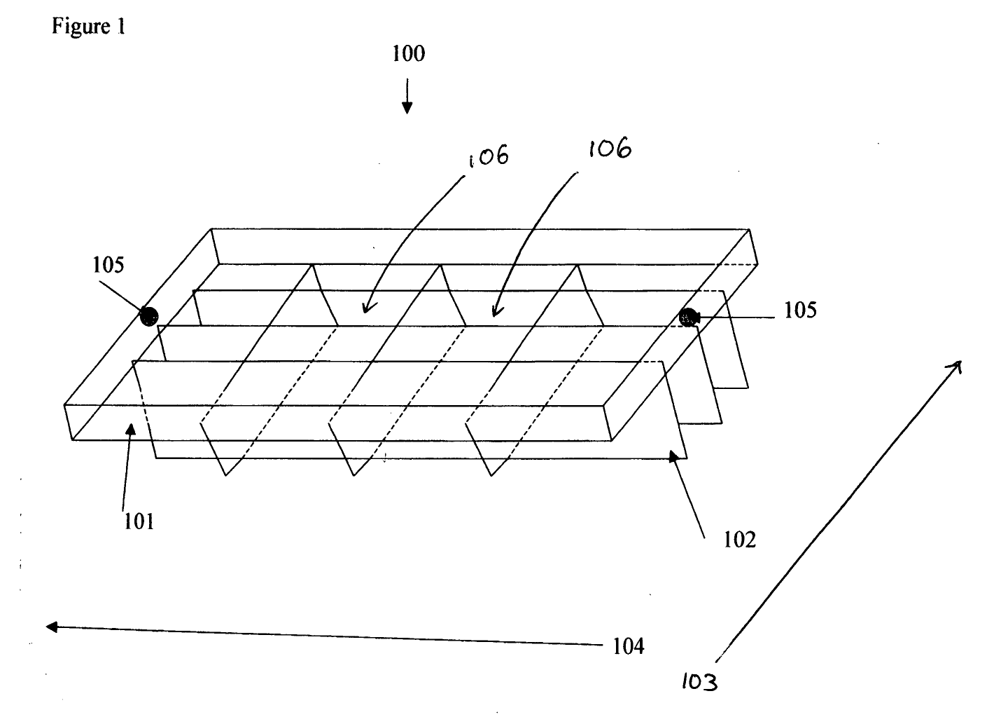

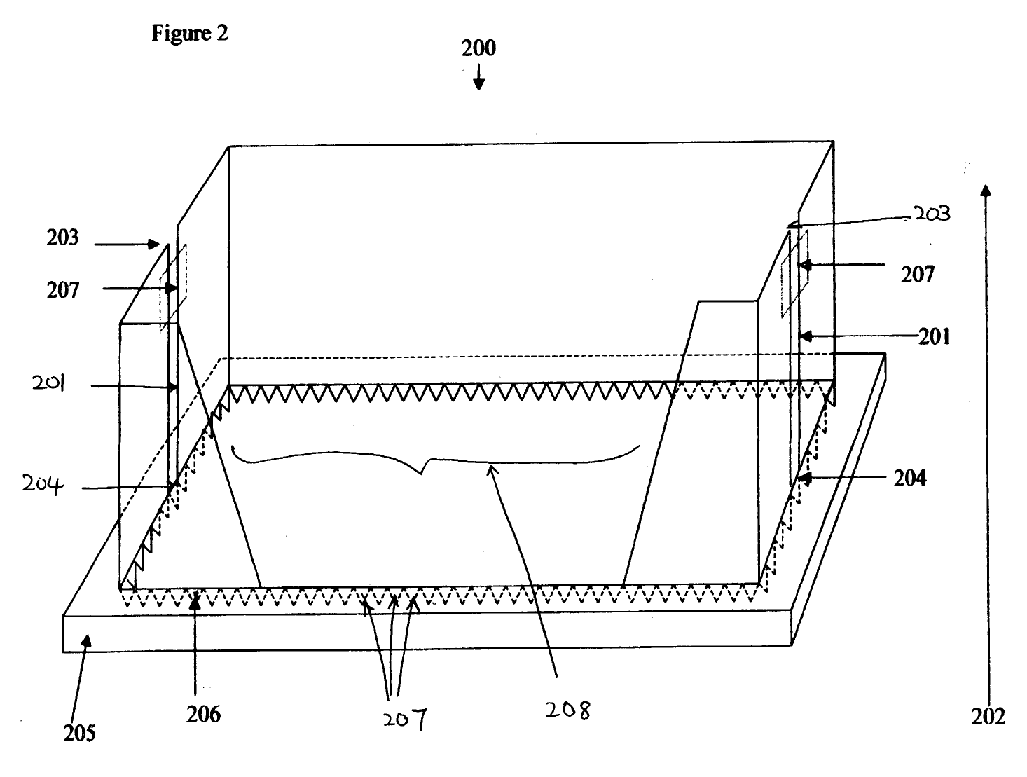

FIG. 1 is one particular embodiment of the top portion 100 of the cutting device. The top portion 100 of the cutting device is responsible for cutting the tofu into uniform pieces. The top portion 100 of the device consists of a casing 101, which is of a size and of a shape that allows the top portion to slidably fit into the bottom portion 200 of the device shown in FIG. 2.

The cutting blades 102 can be secured to the casing 101 using any convenient and/or known method. By way of example, the blades can be buried, deposited, enclosed, fastened, fixed, infixed, ingrained, inlayed, inserted, installed, lodged, implanted, or made integral with the casing during or after construction. The blades 102 can be composed of any convenient and/or known material suitable for kitchenware and can be constructed using any convenient and/or known method of construction. By way of example, the blades can be composed of metal, plastic, hard rubber, ceramics, or wood.

The cutting blades 102 as depicted in FIG. 1 are fixed into place but in other embodiments it is possible for the cutting blades 102 to be adjustable along the X-Axis 103 and the Y-Axis 104, so as to achieve different shaped cuts of food. It is also possible, in an alternate embodiment, to have the ability to add or remove cutting blades. The addition or removal of cutting blades 102 to the casing 101 would result in larger or smaller pieces of tofu.

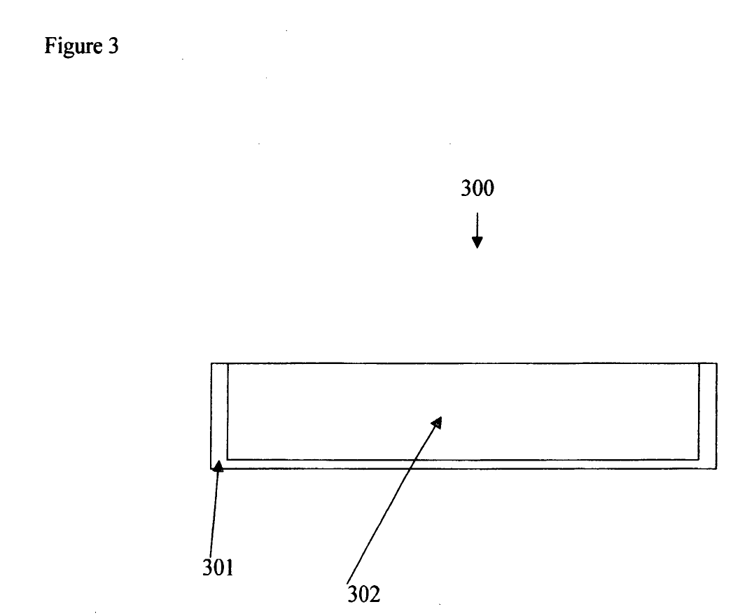

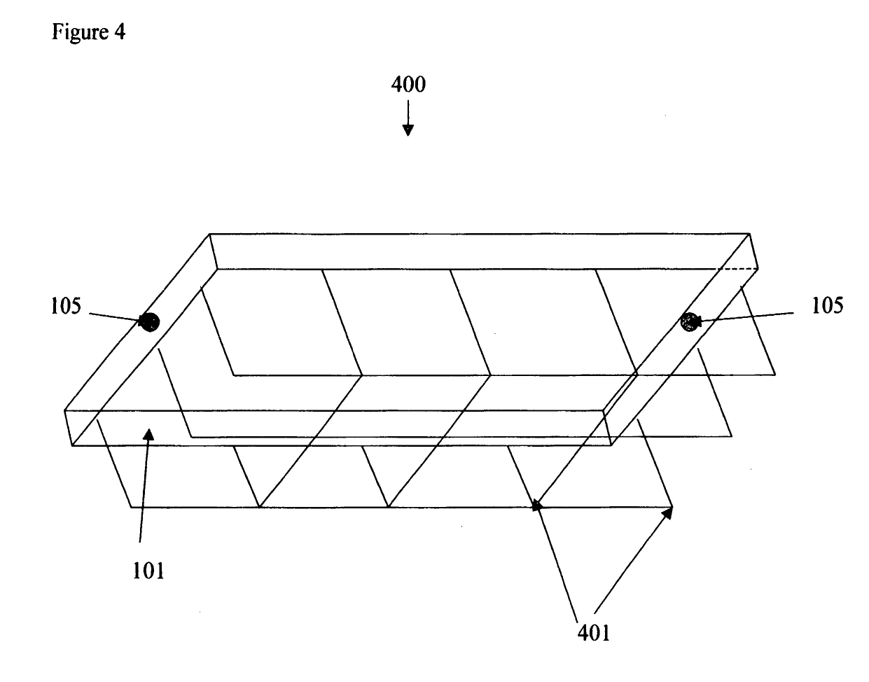

In the embodiment depicted in FIG. 1, the cutting blades 102 are solid and square shaped. One alternate embodiment of the cutting blade structure 300 is demonstrated in FIG. 3. This cutting blade structure 300 has an outer blade edge 301 and the inner portion of the blade 302 has been removed. Another type of cutting blade 102 structure can be seen in FIG. 4, which uses the same casing 101 and locking tabs 105 as the top structure 100 of FIG. 1, yet uses cutting blades 401 made out of wire as a cutting surface. Further possible embodiments of the cutting blades 102 structure could be curved, wavy, or any other structure that would give rise to different pleasing shapes of cut tofu.

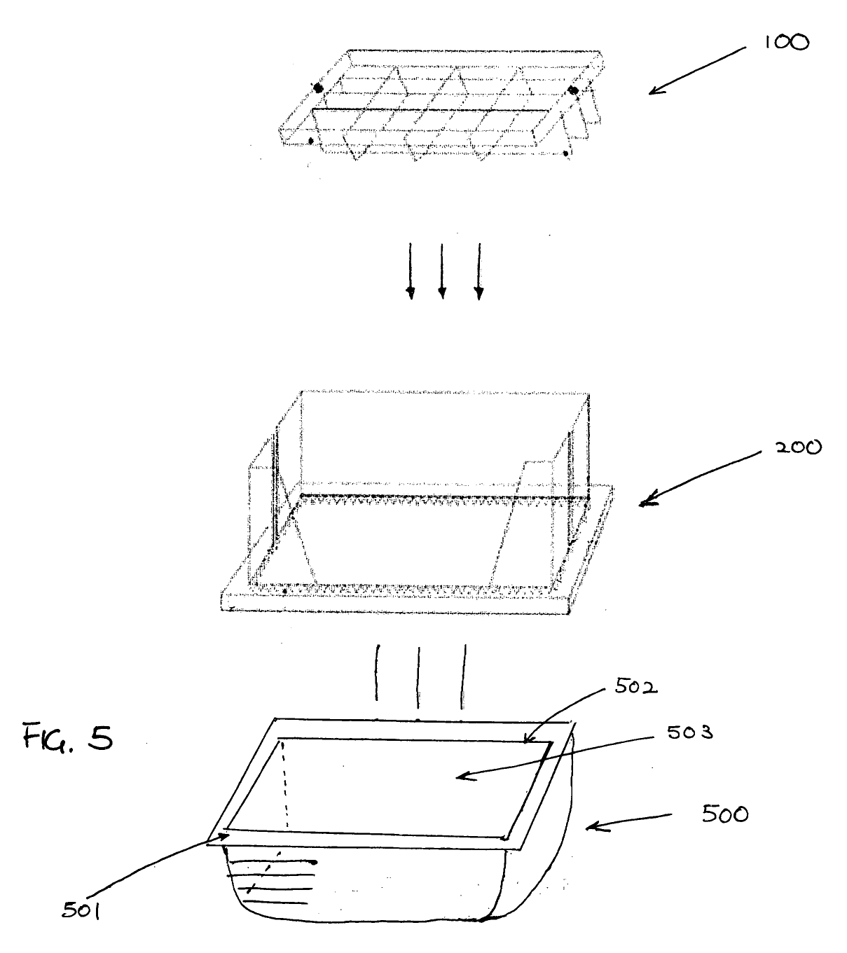

To open a package of tofu, the bottom portion 200 of the device is attached to the tofu container 500, as shown in FIG. 5. This is accomplished by pressing the bottom portion 200 down on top of the tofu container 500. When this happens the outer lip 205 of the bottom portion 200 receives the outer lip 501 of the tofu container 500. In this particular embodiment the outer lip 205 is fixed but in alternate embodiments an adjustable lip may be used.

In this particular embodiment the inner lip 206 of the bottom portion 200 is integral with a serrated cutting surface 207. The cutting surface 207 acts to cut through all four sides of the top film 503 of the package as the bottom portion 200 is pressed down and secured onto the tofu container 500. The film, separated from the package, can then be removed through the opening on the front side of the bottom portion 208 and discarded.

Alternate embodiments of the bottom portion 200 can have straight edged cutting surfaces on the inner lip, a movable cutting surface, or no cutting surface at all. The cutting surface can be secured to the bottom portion using any convenient and/or known method. By way of example, the cutting surface can be buried, deposited, enclosed, fastened, fixed, infixed, ingrained, inlayed, inserted, installed, lodged, implanted, or made integral with the bottom portion during or after construction. The cutting surface 207 can be composed of any convenient and/or known material suitable for kitchenware and can be constructed using any convenient and/or known method of construction. By way of example, the cutting surface can be composed of metal, plastic, hard rubber, ceramics, or wood.

Once the bottom portion 200 is secured on top of the package of tofu 500, and the top film 503 is cut and discarded, the top portion 100 is lowered onto the bottom portion 200. See FIG. 5. The fit and orientation between the top portion 100 and the bottom portion 200 is governed by the placement of guide tabs 105 and the corresponding guide grooves 201. In the embodiment of the bottom portion 200 shown in FIG. 2, the guide grooves 201 correspond to the guide tabs 105 of the top portion 100 of FIG. 1. Alternate embodiments of locking tabs 105 and guide grooves 201 are possible with more tabs and grooves or varied locations on the bottom portion 200 and top portion 100.

By lining up the guide tabs 105 of the top portion 100 with the guide groves 201 of the bottom portion, the top portion is able to smoothly slide along the y-axis 202 from the top opening of the guide grooves 203 along the guide grooves 201 until the top portion 100 is stopped by the guiding tabs 105 reaching the bottom 204 of the guide grooves 201.

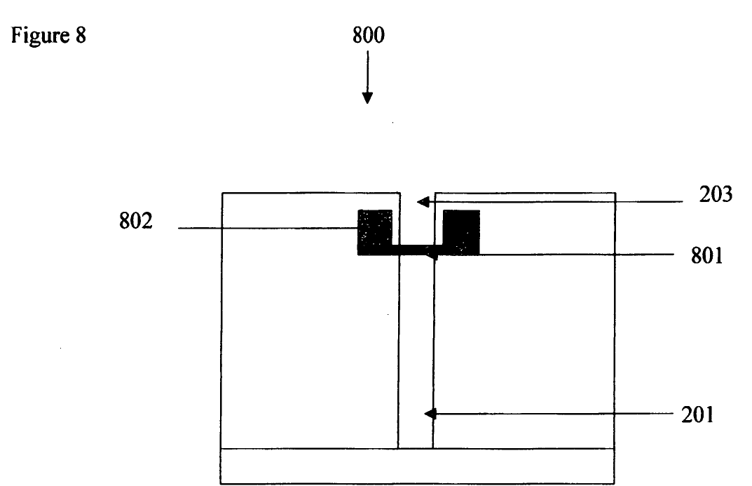

In the embodiment of the device shown in FIG. 2, the bottom portion 200 has elastic tension mechanisms 207 positioned below the top opening of the guide grooves 203. This mechanism can be seen more clearly in FIG. 8. When the top portion 100 is placed into the bottom portion 200 the locking tabs 105 fit into top portion 203 of the guide grooves 201. The locking tabs 105 then encounter the catch piece 801. As the top portion 100 is pressed down into the tofu container 500 being held by the bottom portion 200 the catch piece 801 puts dynamic tension onto the top piece 100 thru the locking tabs 105 so that the top portion with the cutting blades is retracted out of the tofu once the downward pressure on the top piece 100 is relieved. The dynamic tension is supplied to the catch piece by the tension mechanisms 802. In this particular embodiment the tension mechanisms 802 are rubber bands. However, any mechanical source of force will do.

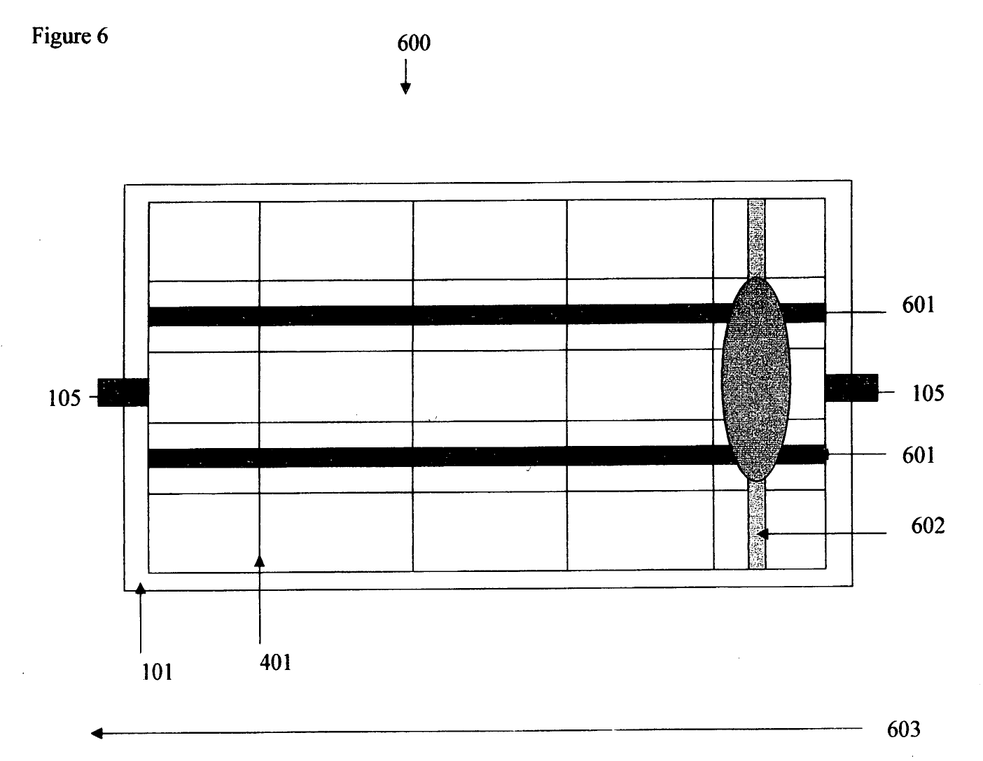

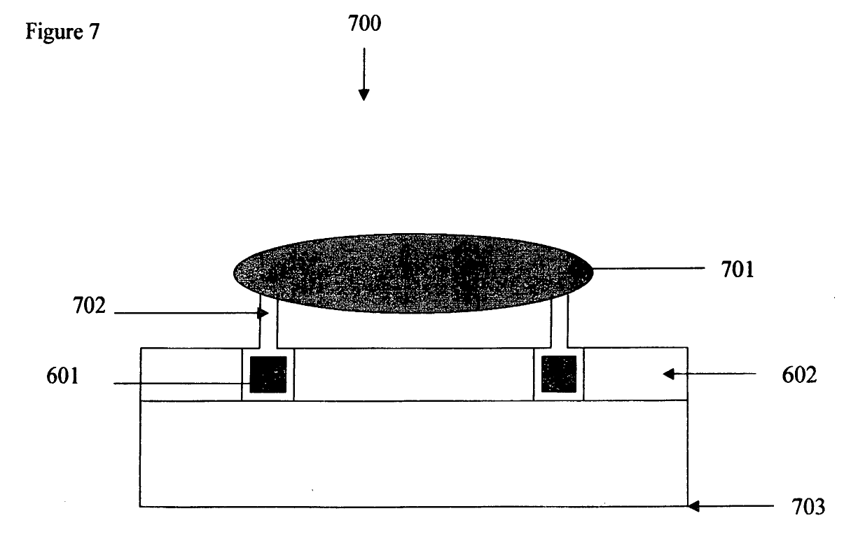

An alternative to the type of cutting blade 102 structure seen in FIG. 4 can be seen in FIG. 6. This alternate embodiment makes use of the same casing 101 and locking tabs 105. It also uses cutting blades 401 made out of wire from FIG. 4. This embodiment has 2 cross rails 601 that support a movable wire blade apparatus 602. The movable wire blade apparatus 602 slides along the cross rails 601 and can be more clearly seen in FIG. 7.

The movable wire blade apparatus 602 has a handle 701 which allows the user to grip and slide the movable cutting blade apparatus 602 along the cross rails 601 along the Y-Axis 603 of cutting blade 102 structure seen in FIG. 6. The handle 701 is attached to the 2 cross rails 601 via connecter struts 702. The connecter struts 702 join the handle 701 to the movable wire blade apparatus 602. A cutting wire blade 703 is a part of the movable wire blade apparatus 602 and is used to create a horizontal cut along the y-axis. By translating the wire blade 703 across the length of the tofu, the vertically-cut pieces created by the cutting blades 401 will be sliced at a pre-determined point on their vertical axis, resulting in twice the number of cut blocks. This process can be repeated to obtain three times, four times, or more number of blocks by repeating the horizontal cuts at different depths.

### Operation

First, the bottom portion 200 of the device is firmly pressed down on top of the tofu package 500. The outer lip 205 of the bottom portion fits over the outside of the outer lip 501 of the tofu container 500. At the same time the cutting surface inner lip 207 of the bottom portion 200 is forced through the protective top film 503 of the tofu container 500 and into contact with the inner lip 502 of the tofu container 500.

This serves to cut through the sides of the protective top film 503 of the tofu container 500 and bring the inner lip 206 of the bottom portion 200 into contact with the inner lip 502 of the tofu container 500. The protective top film 503 that has been cut is removed through the opening on the front side of the bottom portion 208.

The top portion 100 is then placed on top of the bottom portion 200, which is mated to the tofu container 500. The joining of these the top portion 100 and the bottom portion 200 pieces are governed by the fit between the guiding tabs 105 and the guide grooves 201. Once the proper orientation dictated by the guiding tabs 105 and guide grooves 201 is achieved the top portion 100 will slide into the bottom portion.

A minimum amount of force is then applied to the top of the top portion 100. This pushes the cutting blades 102 of the top portion 100 down into the tofu present in the tofu container 300, until the bottom of the tofu container 300 is reached by the blades. At this point, the single block of tofu is cut into smaller blocks, each with the desired uniform size and straight edge. When pressure is relieved on the top portion, the spring mechanism returns the top portion 100 to the top, thereby retracting the blades 102 from the tofu.

With the embodiment of the device with the movable wire blade apparatus 602, the user grips the handle 701 and slides the movable cutting blade apparatus 602 along the along the Y-Axis, thereby translating the horizontal cutting wire blade 703 along the length of the tofu. The tofu, already vertically cut, is sliced horizontally, resulting in twice the number of cut blocks. This process can be repeated for further horizontal cuts, which would result in blocks of smaller size.

The food preparer then holds the bottom of the tofu package with one hand, and press down with the other hand on the device to securely hold it to the package. The device and package combination is then brought over to a food container and inverted, with the blocks of tofu falling through the openings 106 in the casing 101 of the top portion 100 and into the food container.

Alternatively, the top portion and bottom portion, now mated, can be simply lifted from the package. The tofu container is now filled with tofu pieces of the desired uniform shape and size.

Although the above discussion uses tofu as an example of a food that can be used with the device, it is to be understood that other foods may be used. By way of example, pudding, jello, breads, cakes, ice cream, and fruits may also be used with the device.

Although the device has been described in detail for the purpose of illustration, it is to be understood and appreciated that such detail is solely and purely for the purpose of example, and that many other variations, modifications and applications of the invention can be made by those skilled in the art without departing from the spirit and scope of the invention.

What is claimed is:

1. An apparatus for cutting tofu and other foods comprising:
a bottom portion which fits on top of a container of food;
a top portion that slidably fits into said bottom portion, said top portion comprising a casing and cutting blades, said cutting blades being arranged in a pattern within the casing so as to provide cut shapes of a soft food;
said bottom portion guiding the top portion while said cutting blades cuts the contents of the container of food.

2. The apparatus of claim 1, wherein the top portion makes use of cutting blades that are fixed.

3. The apparatus of claim 1, wherein the top portion makes use of cutting blades that are adjustable along the X-axis and Y-axis.

4. The apparatus of claim 1, wherein the top portion makes use of cutting blades that can be added or removed.

5. The apparatus of claim 1, wherein the top portion makes use of cutting blades selected from a group consisting of metal, glass, wood, rubber, plastic, or ceramic.

6. The apparatus of claim 1, wherein the top portion makes use of cutting blades that are solid.

7. The apparatus of claim 1, wherein the top portion makes use of cutting blades that have an outer edge but have an inner portion of the blade removed.

8. The apparatus of claim 1, wherein the top portion makes use of cutting blades that are wire.

9. The apparatus of claim 1, wherein the top portion makes use of cutting blades that are straight.

10. The apparatus of claim 1, wherein the top portion makes use of cutting blades that are curved.

11. The apparatus of claim 1, wherein the top portion makes use of cutting blades that are orientated so as to create shapes within the cut food.

12. The apparatus of claim 1, wherein the bottom portion further comprises a cutting surface on the bottom to open a container of food.

13. The apparatus of claim 1, wherein the bottom portion further comprises an opening through which the opened packaging can be removed.

14. The apparatus of claim 1, wherein the bottom portion is securely fitted onto a top of the container of food via a fixed outer and inner lip that fits over the lip present on a container of food.

15. The apparatus of claim 1, wherein the bottom portion is securely fitted onto the top of a container of food via an adjustable outer and inner lip that fits over the lip present on the container of food.

16. The apparatus of claim 1, wherein the casing of the top portion has openings through which the cut food can pass through.

17. The apparatus of claim 1, wherein the top portion slidably fits into the bottom portion via a protrusion and groove locking system.

18. The apparatus of claim 1, wherein the top portion further comprises a translatable cutting blade that is used to cut the food along its Y-Axis at a depth along the Z-Axis.

19. A method for cutting food into uniform pieces by utilizing a cutting device comprising the steps of:
securing a bottom portion of the cutting device over a food container, whereby a cutting edge on a bottom side opens the food container;
aligning and mating a top portion of the cutting device onto said bottom portion;
said top portion being integral with cutting blades;
pressing the top portion down along a guide provided by the bottom portion of the cutting device into the food container until the bottom of the food container is reached and the food is cut into pieces.

20. The method of claim 19, further comprising the step of:
translating a horizontal blade across the length of the food at a selected depth along the Y-axis to obtain smaller pieces of food.
